(19) United States
(12) Patent Application Publication
(10) Pub. No.: US 2004/0161640 A1
(43) Pub. Date: Aug. 19, 2004

(54) Quick recharge energy storage device, in the form of thin films

(76) Inventor: Raphael Salot, Lans en Vercors (FR)

Correspondence Address: Oliff & Berridge, PO Box 19928, Alexandria, VA, 22320, US

(21) Appl. No.: 10/250,769

(22) PCT Filed: Oct. 21, 2002
(86) PCT No.: PCT/FR02/03588

(30) Foreign Application Priority Data
Oct. 22, 2001 (FR) 01 13568

(51) Int. Cl. H01M 16/00; H01M 2/00

(52) U.S. Cl. 429/9; 429/162

(57) ABSTRACT

The quick recharge energy storage device has a sufficient capacity due to the combination of a micro-battery and at least one micro-supercapacitor connected between two terminals of an integrated circuit. The integrated circuit, powered by the micro-battery, monitors high-speed (less than one second) charge of the micro-supercapacitors from an external energy source. The micro-supercapacitor can be connected in parallel with the micro-battery so as to subsequently recharge the micro-battery during the necessary time. The micro-battery provides a sufficient energy capacity, while the micro-supercapacitors allow high recharging speeds compatible with various applications (smart cards, smart labels, micro-system power supply, etc . . . ). The micro-battery and micro-supercapacitors are preferably formed on the same substrate, either side by side or stacked. Series connection of several micro-supercapacitors provides sufficient voltage for charging the micro-battery.

### BACKGROUND OF THE INVENTION

The invention relates to an energy storage device comprising a battery and at least one supercapacitor.

### STATE OF THE ART

Hybrid storage devices associating a supercapacitor and a battery connected in parallel have in particular been described in U.S. Pat. No. 6,117,585, U.S. Pat. No. 6,187,061, and the article “Le supercondensateur et la batterie se marient pour fournir de l'énergie” by A. Rufer (Electronique, CEP Communication, Paris n°100, February 2000). These devices combine the advantages of their two components and notably enable a large quantity of energy to be stored while having a large instantaneous power available. However none of these devices can be integrated in a chip.

Furthermore, a lithium micro-battery, in the form of thin films, the thickness whereof is comprised between 7 μm and 30 μm (preferably about 15 μm) and which is formed by chemical vapor deposition (CVD) or physical vapor deposition (PVD) is for example described in the document WO-A-9,848,467.

Recharging a micro-battery is in general completed after a few minutes charging. The charging time of micro-batteries does however constitute an obstacle to their use in a large number of applications (smart cards, smart labels, micro-system power supply, etc . . . ) which require the possibility of high-speed recharging while having a sufficient energy capacity. An energy storage device integrated in a smart card used for banking transactions must for example be able to be recharged in less than one second.

### OBJECT OF THE INVENTION

The object of the invention is to provide an energy storage device not presenting the above drawbacks and, more particularly, enabling high-speed recharging without reducing the energy capacity, while being able to be integrated in a chip.

This objective is achieved by a device according to the appended claims, and more particularly by a device wherein the battery and supercapacitor are respectively formed by a micro-battery and a micro-supercapacitor achieved in the form of thin films, the micro-supercapacitor being connected between two terminals of a charging monitoring circuit comprising means for monitoring closing of at least one normally open electronic switch, so as to connect the micro-supercapacitor and the micro-battery in parallel to recharge the micro-battery from the micro-supercapacitor.

According to a development of the invention, the micro-battery and the micro-supercapacitors are formed on one and the same insulating substrate, either side by side or stacked.

### BRIEF DESCRIPTION OF THE DRAWINGS

Other advantages and features will become more clearly apparent from the following description of particular embodiments of the invention given as non-restrictive examples only and represented in the accompanying drawings in which:

FIG. 1 represents, in cross-section, a particular embodiment of a micro-battery able to be used in an energy storage device according to the invention.

FIG. 2 represents, in cross-section, a particular embodiment of a micro-supercapacitor able to be used in an energy storage device according to the invention.

FIG. 3 illustrates the connections between a micro-battery and micro-supercapacitors of a device according to the invention.

FIGS. 4 and 5 illustrate a first embodiment of a device according to the invention, respectively in top view and cross-section along A-A.

FIGS. 6 and 7 illustrate a second embodiment of a device according to the invention, respectively in top view and cross-section along B-B.

### DESCRIPTION OF PARTICULAR EMBODIMENTS

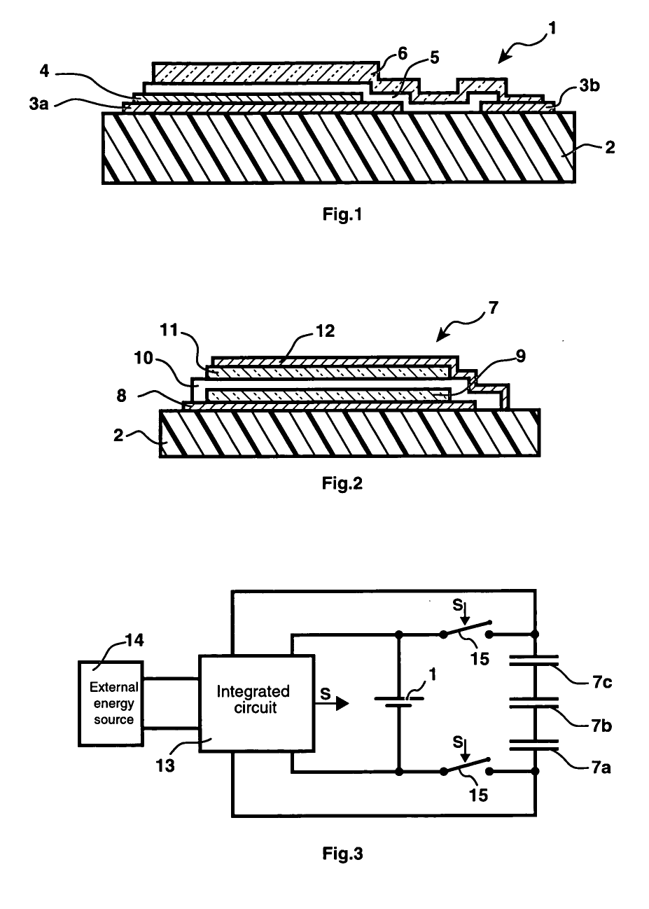

The operating principle of a micro-battery is based on insertion and de-insertion of an alkaline metal ion or a proton in the positive electrode of the micro-battery, preferably a lithium ion Li⁺ originating from a metallic lithium electrode. In FIG. 1, the micro-battery is formed on an insulating substrate 2 by a stack of layers obtained by CVD or PVD, respectively constituting two current collectors 3a and 3b, a positive electrode 4, a solid electrolyte 5, a negative electrode 6 and possibly an encapsulation (not shown).

The elements of the micro-battery 1 can be made of various materials:

The metal current collectors 3a and 3b can for example be platinum (Pt), chromium (Cr), gold (Au) or titanium (Ti) based.

The positive electrode 4 can be formed by LiCoO₂, LiNiO₂, LiMn₂O₄, CuS, CuS₂, WO_{y}S_{z}, TiO_{y}S_{z}, V₂O₅ or V₃O₈ and lithium forms of these vanadium oxides and metal sulfides. Depending on the materials chosen, thermal annealing may be necessary to increase the crystallization of the films and their insertion property. Nevertheless, certain amorphous materials, in particular titanium oxysulfides, do not require annealing while enabling a high insertion of lithium ions.

The solid electrolyte 5, which is a good ion conductor and electric insulator, can be formed by a vitreous material with a boron oxide, lithium oxides or lithium salts base.

The negative electrode 6 can be formed by metallic lithium deposited by thermal evaporation, by a lithium-based metal alloy or by an insertion compound of the SiTON, SnNₓ, InNₓ, SnO₂, etc. type.

The object of the possible encapsulation is to protect the active stacking from the external environment and, more specifically, from humidity. It can be formed by ceramic, by a polymer (hexamethyldisiloxane, parylene, epoxy resins), by a metal or by a superposition of layers of these different materials.

Depending on the materials used, the operating voltage of a micro-battery is comprised between 2V and 4V, with a surface capacity of about 100 μAh/cm². The fabrication techniques used enable all the required shapes and surfaces to be obtained, but recharging of the micro-battery is in general only completed after a few minutes of charging.

Micro-supercapacitors have moreover been achieved in laboratory in the form of thin films with the same type of technology as micro-batteries. As represented in FIG. 2, a micro-supercapacitor is formed by stacking of thin layers, on an insulating substrate 2 preferably made of silicon, respectively constituting a bottom current collector 8, a bottom electrode 9, a solid electrolyte 10, a top electrode 11 and a top current collector 12. An encapsulation (not shown) can be added if required, in the same way as for a micro-battery, although the elements constituting the micro-supercapacitor 7 are less sensitive to air than lithium.

The elements of the micro-supercapacitor 7 can be made from various materials. The electrodes 9 and 11 can be carbon-based or metal oxides-based such as RuO₂, IrO₂, TaO₂ or MnO₂. The solid electrolyte 10 can be a vitreous electrolyte of the same type as that of the micro-batteries. The micro-supercapacitor 7 can be formed by the insulating silicon substrate 2, for example in five successive deposition steps:

In a first step, the bottom current collector 8 is for example formed by deposition of a layer of platinum with a thickness of 0.2±0.1 μm, by radiofrequency cathode sputtering.

In a second step, the bottom electrode 9, made of ruthenium oxide (RuO₂) for example, is fabricated from a metallic ruthenium target, by reactive radiofrequency cathode sputtering in a mixture of argon and oxygen (Ar/O₂) at ambient temperature. The layer formed has for example a thickness of 1.5±0.5 μm.

In a third step, a layer with a thickness of 1.2±0.4 μm for example constituting the solid electrolyte 10 is formed. This is a conducting glass of Lipon type (Li₃PO_{2.5}N_{0.3}) obtained by cathode sputtering under partial nitrogen pressure with a Li₃PO₄or 0.75(Li₂O)-0.25(P₂O₅) target.

In a fourth step, the top electrode 11, made of ruthenium oxide (RuO₂) for example, is fabricated in the same way as the bottom electrode 9 during the second step.

In a fifth step, the top current collector 12, made of platinum, is formed in the same way as the bottom current collector 8 during the first step.

The micro-supercapacitor 7 thus obtained can have a surface capacity of about 10 μAh/cm² and its full charge can be obtained in less than one second, typically in a few hundred microseconds. Its small surface capacity, imposing too frequent recharging, does not enable it to be used as energy source in a large number of applications.

The quick recharge energy storage device according to the invention has a sufficient capacity due to the combination of a micro-battery 1 and at least one micro-supercapacitor 7. The micro-battery 1 provides a sufficient energy capacity whereas the micro-supercapacitors allow high recharging speeds to be achieved compatible with the different applications envisaged (smart cards, smart labels, micro-system power supply, etc . . . ). The micro-supercapacitors then perform recharging of the micro-battery 1 during the necessary time. The thickness of a micro-battery or a micro-supercapacitor is 10 to 30 times smaller than that of a mini-battery or a mini-supercapacitor using liquid electrolytes, which enables the storage device according to the invention to be integrated in a chip.

In a particular embodiment illustrated in FIG. 3, the energy storage device comprises a micro-battery 1 and three micro-supercapacitors 7a, 7b and 7c. The three micro- supercapacitors 7a, 7b and 7c are connected in series between two terminals of an integrated circuit 13. The integrated circuit 13, supplied by power supply terminals connected to the micro-battery 1, monitors high-speed (less than one second) recharging of the micro-supercapacitors from an external energy source 14. This recharging can be performed in any known manner, for example by contact or by radiofrequency when a smart card comprising the integrated circuit 13 and the energy storage device according to the invention is inserted in a reader. The integrated circuit 13 subsequently performs parallel connection of the micro-battery 1 and of the series circuit formed by the three micro-supercapacitors, by means of a control signal S controlling closing of at least one normally open electronic switch 15, so as to recharge the micro-battery during the necessary time (for example a few minutes). Series connection of several micro-supercapacitors enables a sufficient voltage to be available to charge the micro-battery 1.

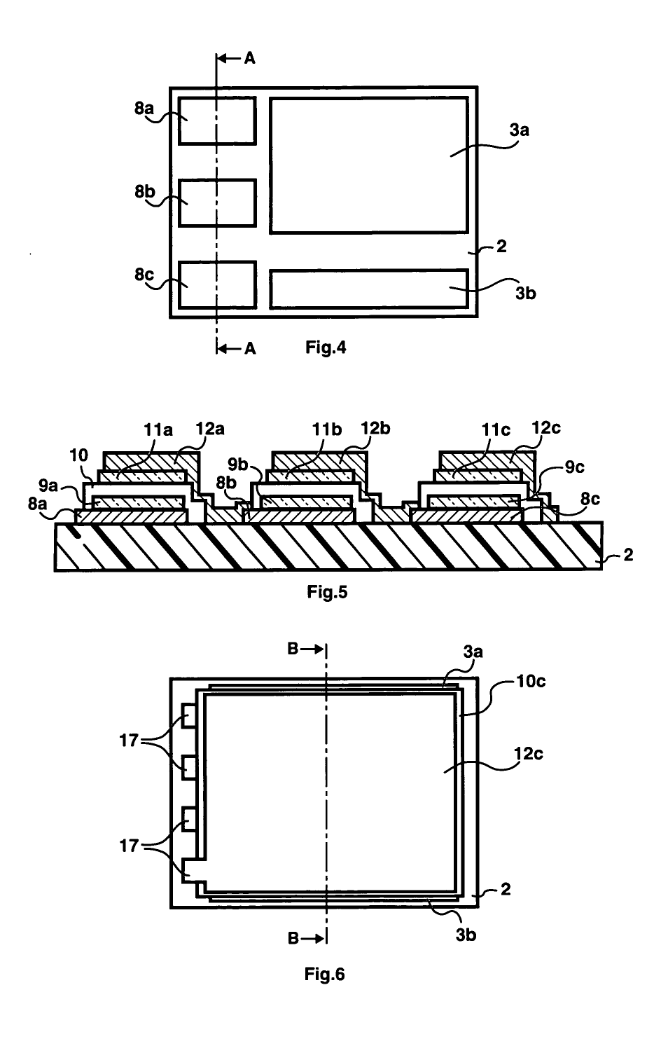

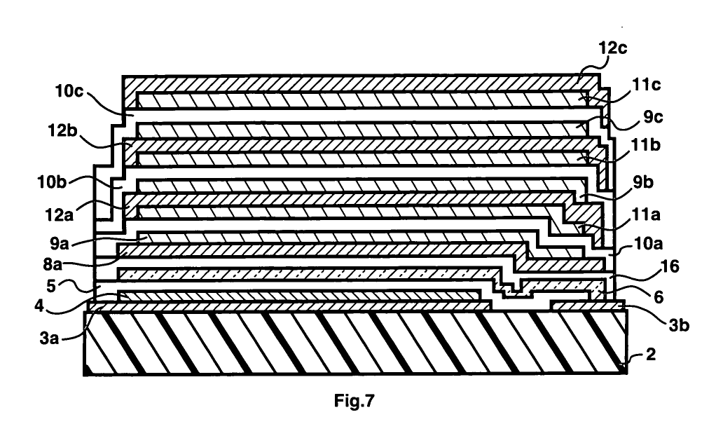

The micro-battery 1 and micro-supercapacitors 7 are preferably formed on the same substrate 2, either side by side (FIGS. 4 and 5) or stacked (FIGS. 6 and 7). The substrate 2 also preferably supports the integrated circuit 13 and the electronic switches 15. Thin film deposition techniques of the same type can be used for fabrication of the micro-battery and of the micro-supercapacitors. The micro-battery 1 and micro-supercapacitors 7 preferably comprise identical materials for the current collectors on one hand and for the solid electrolyte on the other hand, which enables the manufacturing time to be reduced.

In a first embodiment, illustrated in FIGS. 4 and 5, the micro-battery and the micro-supercapacitors are arranged side by side on the substrate 2. This enables certain layers of the micro-battery and micro-supercapacitors to be achieved simultaneously but requires a larger surface than the second embodiment, illustrated in FIGS. 6 and 7, wherein the micro-battery and micro-supercapacitors are stacked.

In the first embodiment represented, the micro-battery 1 and three micro-supercapacitors 7a, 7b and 7c are arranged side by side on an insulating silicon substrate 2 with a surface area of 9 Cm². The micro-battery 1 is formed by a stacking of Pt/TiOS/Lipon/Li layers. It has an operating mean voltage of about 2V and a capacity of 400 μAh. Each micro-supercapacitor, having a voltage of about 1V and a capacity of about 15 μAh, is formed by a stacking of Pt/RuO₂/Lipon/RuO₂ layers. Series coupling of the three micro-supercapacitors enables a voltage of about 3V necessary for full recharging of the micro-battery to be achieved.

The micro-battery and the three micro-supercapacitors can be formed in seven successive deposition steps:

In a first step, represented in FIG. 4, the current collectors 3a and 3b of the micro-battery and the bottom current collectors 8a, 8b and 8c of the three micro-supercapacitors are formed side by side on the substrate 2 by radiofrequency cathode sputtering of a layer of platinum (Pt) with a thickness of 0.2±0.11 μm.

In a second step, the bottom electrodes 9a, 9b and 9c of the micro-supercapacitors, made of ruthenium oxide (RuO₂), are achieved from a metallic ruthenium target by reactive radiofrequency cathode sputtering in a mixture of argon and oxygen (Ar/O₂) at ambient temperature. The layer formed has a thickness of 1.5±0.5 μm.

In a third step, a layer with a thickness of 1.5±0.5 μm constituting the positive electrode 4 made of titanium oxysulfide (TiO_{0.2}S₁₄) is formed on the first current collector 3a of the micro-battery. This layer is obtained from a metallic titanium (Ti) target by reactive radiofrequency cathode sputtering in a mixture of argon and hydrogen sulfide (Ar/H₂S) at ambient temperature.

In a fourth step, a layer with a thickness of 1.2±0.4 μm constituting the solid electrolyte 5 of the micro-battery and the solid electrolyte 10 of each of the micro-supercapacitors is formed. This is a conducting glass of Lipon type (Li₃PO_{2.5}N_{0.3}) obtained by reactive cathode sputtering under partial nitrogen pressure with a Li₃PO₄or 0.75(Li₂O)-0.25(P₂O₅) target.

In a fifth step, the top electrodes 11a, 11b and 11c of the three micro-supercapacitors, made of ruthenium oxide (RuO₂), are fabricated in the same way as the bottom electrodes during the second step.

In a sixth step, a layer of lithium (Li) with a thickness of 5±2 μm constituting the negative electrode 6 of the micro-battery is formed by secondary vacuum evaporation by heating the metallic lithium by Joule effect in a crucible at 450° C.

In a seventh step, the top current collectors 12a, 12b and 12c of the micro-supercapacitors, made of platinum, are formed in the same way as the bottom current collectors during the first step. FIG. 5 illustrates, in cross-section, the three micro-supercapacitors obtained at the end of the seventh step. In this embodiment, the top collectors 12a and 12b come into contact respectively with the collectors 8b and 8c of the adjacent micro-supercapacitor thus automatically making the series connection of the three micro-supercapacitors during the seventh step.

The connections between the micro-battery and the micro-supercapacitors, by means of the electronic switches 15, as well as their connections to the integrated circuit 13, are subsequently made by any suitable means. The device as a whole is then preferably protected from the external environment by encapsulation, for example by successive deposition of layers of polymer and metal.

The second and third steps can possibly be inverted. The same is true for the fifth and sixth steps and, respectively, for the sixth and seventh steps.

In the second embodiment represented, the micro-battery 1 and three micro-supercapacitors 7a, 7b and 7c are stacked on a silicon insulating substrate 2 with a surface area of 8 cm². The materials used are the same as in the first embodiment. Stacking enables the surface available for the micro-battery and for each of the micro-supercapacitors to be increased, and consequently enables their energy capacity to be increased. It is thus possible to obtain a micro-battery having a capacity of 800 μAh and a capacity of 80 μAh for the set of micro-supercapacitors. The number of deposition steps required is on the other hand larger.

The micro-battery and the three micro-supercapacitors can be formed in eighteen successive deposition steps, the characteristics of the different layers being identical to those of the first embodiment:

The current collectors 3a and 3b, positive electrode 4, electrolyte 5 and negative electrode 6 of the micro-battery are successively formed by stacking of layers of platinum (1^{st} step), TiOS (2^{nd} step), Lipon (3^{rd} step) and lithium (4^{th} step).

In a fifth step, an electrically insulating layer 16 is formed on the micro-battery before the micro-supercapacitors are formed. In a preferred embodiment, the insulating layer 16 is formed by a layer of solid electrolyte made of Lipon.

The three micro-supercapacitors are then successively formed in superposed manner above the insulating layer 16. The top collector 12a of the first micro-supercapacitor 7a also constitutes the bottom collector of the second micro-supercapacitor 7b. Likewise, the top collector 12b of the second micro-supercapacitor 7b also constitutes the bottom collector of the third micro-supercapacitor 7c. The three micro-supercapacitors are thus automatically connected in series.

The first micro-supercapacitor 7a is thus formed by stacking of a layer of platinum (6^{th} step) constituting the bottom current collector 8a, a layer of RuO₂ (7^{th} step) constituting the bottom electrode 9a, a layer of Lipon (8^{th} step) constituting the solid electrolyte 10a, a layer of RuO₂ (9^{th} step) constituting the top electrode 11a and a layer of platinum (10^{th} step) constituting the top current collector 12a.

The second micro-supercapacitor 7b is then formed by stacking on the current collector 12a, constituting its bottom current collector, of a layer of RuO₂ (11^{th} step) constituting the bottom electrode 9b, a layer of Lipon (12^{th} step) constituting the solid electrolyte 10b, a layer of RuO₂ (13^{th} step) constituting the top electrode 11b and a layer of platinum (14^{th} step) constituting the top current collector 12b.

The third micro-supercapacitor 7c is then formed by stacking on the current collector 12b, constituting its bottom current collector, of a layer of RuO₂ (15^{th} step) constituting the bottom electrode 9c, a layer of Lipon (16^{th} step) constituting the solid electrolyte 10c, a layer of RuO₂ (17^{th} step) constituting the top electrode 11c and a layer of platinum (18^{th} step) constituting the top current collector 12c.

The storage device thus obtained is represented in FIGS. 6 and 7, respectively in top view and in cross-section. The current collectors 8a, 12a, 12b and 12c respectively formed during the 6^{th}, 10^{th}, 14^{th} and 18^{th} steps each comprise a salient zone 17 on one side constituting the offset output terminals of the micro-supercapacitors. The zones 17 of the current collectors 8a and 12c are designed to be connected to the integrated circuit 13 and, via electronic switches 15, to the micro-battery. The zones 17 of the current collectors 12b and 12c are not indispensable, but they can be used if intermediate voltages are required.

The insulating layer 16 can be eliminated if the device only comprises a single electronic switch 15 to connect the top current collector 12c of the third micro-supercapacitor 7c to the current collector 3a of the micro-battery. The bottom current collector 8a of the first micro-supercapacitor 7a is then directly in contact with the negative electrode 6 of the micro-battery.

As represented in FIG. 7, the solid electrolyte layers 10a, 10b and 10c can totally cover the previous layers, with the exception of the zones 17 of the current collectors of the micro-supercapacitors and of a part of the current collectors 3a and 3b of the micro-battery to allow subsequent connections. They thus constitute an electrical insulator coating almost all the side faces of the stacking.

In the two embodiments described above, all the fabrication steps of the storage device can be performed at ambient temperature without subsequent annealing. The modular architecture of the device, in particular the surface of the different elements, the number of micro-supercapacitors connected in series and the materials used determining the operating voltage and surface capacity of the micro-battery and micro-supercapacitors, is adapted to each application, in particular to its energy consumption and recharging frequency.

1. An energy storage device comprising a battery and at least one supercapacitor, device characterized in that the battery and supercapacitor are respectively formed by a micro-battery (1) and a micro-supercapacitor (7) achieved in the form of thin films, the micro-supercapacitor (7) being connected between two terminals of a charging monitoring circuit (13) comprising means (S) for monitoring closing of at least one normally open electronic switch (15), so as to connect the micro-supercapacitor (7) and the micro-battery (1) in parallel to recharge the micro-battery from the micro-supercapacitor (7).

2. Device according to claim 1, characterized in that the charging monitoring circuit (13) is supplied by the micro-battery (1).

3. Device according to one of claims 1 and 2, characterized in that it comprises a plurality of micro-supercapacitors (7a, 7b, 7c) connected in series between the terminals of the charging monitoring circuit (13), the series circuit formed by the micro-supercapacitors (7a, 7b, 7c) being connected in parallel to the micro-battery when closing of the switch (15) takes place.

4. Device according to any one of claims 1 to 3, characterized in that the micro-battery (1) comprises a solid electrolyte (5), arranged between first and second electrodes (4, 6), and first and second current collectors (3a, 3b) respectively connected to the first and second electrodes, the micro-supercapacitor (7) being formed by a stacking of layers respectively constituting a bottom current collector (8), a bottom electrode (9), a solid electrolyte (10), a top electrode (11) and a top current collector (12).

5. Device according to claim 4, characterized in that the solid electrolytes (5, 10) of the micro-battery and micro-supercapacitors are made from one and the same material.

6. Device according to any one of claims 1 to 5, characterized in that the micro-battery (1) and micro-supercapacitors (7) are formed on one and the same insulating substrate (12).

7. Device according to claim 6, characterized in that the micro-battery and micro-supercapacitors are formed side by side on the substrate.

8. Device according to claim 6, characterized in that the micro-battery and micro-supercapacitors are stacked.

9. Device according to claim 8, characterized in that it comprises an insulating layer (16) between the negative electrode (6) of the micro-battery and the bottom collector (8a) of the micro-supercapacitor (7a) that is superposed thereon.

10. Device according to claim 9, characterized in that the insulating layer (16) is made of the same material as the solid electrolytes (5, 10) of the micro-battery and micro-supercapacitors.

11. Device according to any one of claims 8 to 10, characterized in that the solid electrolyte layers (10a, 10b and 10c) of the micro-supercapacitors constitute an electrical insulator coating almost all the side faces of the stacking.
